(19) United States
(12) Patent Application Publication
(10) Pub. No.: US 2019/0161819 A1
(43) Pub. Date: May 30, 2019

(54) METHOD FOR PRODUCING A COMPONENT, COMPONENT AND PRESS FOR PRODUCING A COMPONENT

(71) Applicant: SCHULER PRESSEN GMBH, GOEPPINGEN (DE)

(72) Inventor: MICHAEL WERBS, STUTTGART (DE)

(73) Assignee: SCHULER PRESSEN GMBH, GOEPPINGEN (DE)

(21) Appl. No.: 16/096,291

(22) PCT Filed: Apr. 18, 2017
(86) PCT No.: PCT/DE2017/100308

§ 371 Date: Oct. 25, 2018

(30) Foreign Application Priority Data
Apr. 28, 2016 (DE) 10 2016 107 952.9

(51) Int. Cl. C21D 9/08; B21D 22/02; B21D 37/16; C21D 1/42; C21D 1/673; C21D 8/10; B32B 1/08; B32B 15/01

(52) U.S. Cl. CPC C21D 9/08; B21D 22/022; B21D 37/16; C21D 1/42; C21D 1/673; C21D 2211/008; B32B 1/08; B32B 15/013; C21D 2241/00; B32B 2597/00; C21D 2211/001; C21D 8/105

(57) ABSTRACT

A method to produce a component from a workpiece via a press which includes at least one die to form the workpiece. The workpiece comprises at least one of a metal, a metal alloy and a coating and has a form of a hollow part. The method includes internal high-pressure forming and/or hydraulic back-pressure forming the workpiece via a fluid and the at least one die at a temperature below a first hardening temperature of the workpiece, and subsequently partially or completely hardening the workpiece by heating the workpiece above the first hardening temperature and then immediately cooling the workpiece. The heating and the cooling are each essentially conducted without a forming so that a fabricated component results.

The invention relates to a method to produce a component from a workpiece by means of a press with at least one die to form the workpiece, whereby the workpiece comprises a metal and/or a metal alloy and/or a coating and takes the form of a hollow part. Furthermore, the invention relates to a component and a press to produce a component.

The sheet-metal warm-forming method known as press hardening is used to manufacture higher-strength components. Press hardening of sheet metal parts made of boron-alloyed steels (such as 22MmB5) has been used for many years, for example. The forming and the heat-treatment of the sheet metal component is combined here. For pipes which are formed according to the internal high-pressure forming method, the method of press hardening has not been used to date, since the fluid media, in particular water, used with internal high-pressure forming are not suitable for a temperature range above 900° C.

Moreover, material incompatibilities when warm forming are known. Pipes with zinc coatings cannot be warm-formed above the melting point of the first zinc phases, for example, because otherwise micro-cracks form due to liquid metal embrittlement.

It is also known that uncoated components scale during press hardening and/or the subsequent transfer, which causes a great deal of wear on the die and the component has subsequently to be shot peened to remove the scale. Disadvantageous here are the great effort needed for the post-treatment and the possible warping of the component.

This means that the only production methods known from the Prior Art are those which do not allow the direct fabrication of higher-strength pipes.

DE 43 22 061 C1 describes a device for the simultaneous manufacture of several different partially hollow parts by means of a forming press using the internal high-pressure forming method, whereby the several die arrangements can be closed with the same stroke of the press ram, but the forming is performed with individual control of the different die arrangements despite there being a common internal high-pressure source.

DE 44 16 147 C2 discloses a method to fabricate a curved metal elongated hollow part, whereby two identical sheet metal blanks are fabricated initially and then joined along the longitudinal edges. The joined sheet metal blanks are then expanded in an internal high-pressure forming press by feeding a pressure medium between the two parts of the blanks and formed into the curved metal elongated hollow part.

DE 10 2009 016 874 B4 describes a device for the internal high-pressure forming of a pipe, whereby it has an adjustable die arrangement so that the die can be modified during a die test and a spring back can be compensated.

WO 2014/187623 A1 discloses a method for hardening a component whereby a curved tube is first formed from a flat blank by U-O forming or forming according to the edge rolling technique. The curved pipe is subsequently introduced into the receiving region of a hardening tool enclosing the curved pipe and inductively heated by means of an induction coil integrated in the hardening tool and subsequently hardened by cooling.

The objective of the invention is to improve the Prior Art.

The objective is solved by a method to fabricate a component from a workpiece by means of a press with at least one die to form the workpiece, whereby the workpiece comprises a metal and/or a metal alloy and/or a coating and takes the form of a hollow part, comprising the following steps:
internal high-pressure forming and/or hydraulic back-pressure forming of the workpiece by means of a fluid and the at least one die, whereby the internal high-pressure forming and/or hydraulic back-pressure forming is conducted at a temperature below a first hardening temperature, in particular below a melting point of zinc phases and
subsequent partial or complete hardening of the workpiece by heating the workpiece above the first hardening temperature, in particular above 700° C., preferably above 840° C., and immediate cooling of the workpiece, whereby the hardening and cooling is essentially conducted without any forming so that a fabricated component results.

This thus provides a method whereby hollow, higher-strength components, in particular components with a tensile strength above 1300 MPa after hardening, are manufactured directly from a hollow part, so that the preceding manufacturing and/or forming steps are minimized.

It is therefore possible to also use a conventional pressure medium, such as water at a temperature of below 100° C. or a special oil at a temperature of below 250° C.

Advantageously it has turned out that zinc-coated hollow parts can be formed by the internal high-pressure forming method without micro-crack formation and can subsequently be hardened because of the direct coupling of the heating and immediate cooling, since no major forming of the hollow part now takes place during the hardening.

Furthermore, it has surprisingly turned out that the scaling of uncoated hollow parts was also minimised through the direct coupling of the inductive heating, for example, and immediate cooling for the partial or complete hardening. Alternatively, zinc can be used as a protective coating against scaling in this method, for example.

Hollow components with complex geometries and special strength properties can thus be manufactured from different materials. Fewer joining operations are necessary here and the fabrication can be done directly from a hollow part, whereby several fabrication steps can be integrated.

A higher temperature when internal high-pressure forming reduces the yield strength of the material and the forming can take place at lower pressures and/or allow more complex geometries to be produced.

A key idea of the invention is based on the fact that higher-strength, hollow components are fabricated directly by means of internal high-pressure forming and/or hydraulic back-pressure forming and a subsequent partial or complete hardening from hollow parts with or without coating, in particular zinc coatings, and/or alloy as workpieces. In this case, the metal workpiece is formed by internal high-pressure forming and/or hydraulic back-pressure forming in particular at a sufficiently high temperature, without fluid zinc phases occurring. The workpiece is subsequently brought to the hardening temperature and hardened without any further specific forming.

The following terminology is explained:

A “component” is in particular an individual part of a technically complex system, such as a machine and/or a device, for example, which is made out of one workpiece. The component is in particular produced due to a plastic change in form brought about by the specific forming of a workpiece. A component therefore has in particular almost finished or finished forms and/or geometries.

A “workpiece” is in particular deemed to be an individual, delimited part of a largely solid material, which is processed. In particular a component is manufactured from the workpiece by forming and/or further processing steps.

A “press” is in particular a forming machine with straight relative motion of the die. A number of production methods such as original forming, forming, deep drawing, joining, coating, separating, cutting and/or modification of material properties in particular are carried out in presses. A press is in particular a path-based, energy-based or force-based press. The press can in particular have a forming die for the forming. A method for internal high-pressure forming and/or hydraulic back-pressure forming and/or hardening in particular can be carried out in the press.

A “tool” is in particular an object with which a workpiece is processed, the tool being guided by a person and/or a machine. A tool can in particular be a forming die and/or a machining tool. The die is used in particular in a forming method of fabrication, such as forming and/or hardening, for example. The tool is in particular used in a machine tool and/or a press. The die can in particular consist of a bottom die and a top die and/or two die halves. A die can in particular have an inner contour which is applied to a workpiece and/or hollow part as an outer contour.

“Forming” is in particular a fabrication method whereby metals/alloys are specifically subjected to a plastic change into a different form. In particular, a hollow part and/or a workpiece is converted into a component by forming. Forming can in particular mean deep drawing and/or pressing. Forming can in particular be cold forming, where the workpiece is fed to the forming process in a cold state, for example room temperature. Furthermore, forming can in particular mean semi-hot forming and/or hot forming, whereby with the latter, the workpiece is heated to a temperature above the re-crystallizing temperature of the workpiece, for example, before it is formed.

The term “metal” is used in particular for chemical elements whose atoms bond with each other to form a crystal structure with freely moving electrons (metallic bond). Metals here are deemed to be heavy metals, light metals, precious metals, non-precious metals and/or semi-metals and their alloys in particular. A metal can exist in particular in a solid and/or fluid form. Examples of metals are iron, nickel, copper, chrome, aluminum and titanium.

A “metal alloy” is in particular a metallic material which consists of at least two elements, whereby these together exhibit in particular the feature of a crystalline structure with metallic bond typical for a metal. In particular the type and number of alloying partners, their percentage mass in the alloy and the temperature are crucial for the properties of a metal alloy. A metal alloy can be a ferrous alloy or a nonferrous alloy. Steel, for example, is a metal alloy whose main constituent is iron. Further examples for alloys are iron-nickel (FeNi), chrome-nickel (CrNi), chrome-nickel-molybdenum (CrNiMo) and manganese-boron steel such as 22MnB5.

A “coating” is in particular a firmly adhesive layer of a formless material on the surface of a workpiece, which is applied to the surface of the workpiece by means of a production method. The coating can in particular have a uniform and/or a varying coating thickness and/or several interconnected layers. The coating serves in particular to have an effect on the physical, electrical and/or chemical properties of the workpiece. A coating, for example a zinc-containing coating, can serve to protect the workpiece and/or the components produced therefrom from corrosion, for example. With warm forming, the coatings are used to protect against scale formation, for example.

A “hollow part” is in particular a part which has a hollow cavity in the interior, the hollow cavity being in particular an empty and/or filled space inside the hollow part. A hollow part can in particular have one or more openings. A hollow part can be a hollow cylinder with an inner bore in the circular cylinder along its axis, for example. A hollow part is in particular a pipe. A hollow part has in particular a diameter of between 5 mm and 500 m and a wall thickness of 0.4 mm to 20 mm.

“Internal high-pressure forming” is in particular a forming method whereby a hollow part is expanded, compressed in the axial and/or radial direction and subsequently expanded against a wall of a die by means of a calibration pressure. Internal high-pressure forming is in particular a die-based internal high-pressure forming. The internal high-pressure forming is in particular carried out in a special hydraulic press by means of a two-part die and a pipe, for example, is put into the bottom die. Axial sealing punches are in particular arranged at both sides of the pipe end (horizontal cylinders). After the die has been closed, the axial punches in particular are pressed against the pipe ends and seal them. The pipe is in particular filled with a pressure medium. During the forming process, the sealing punches in particular compress the pipe, while the pressure medium simultaneously expands the pipe while material is flowing axially and thus makes the pipe fit to the contour of the die. The flow of material can in particular be additionally controlled by a back-stop. The workpiece is in particular formed by means of the calibration pressure such that its contour accurately corresponds to the inner contour of the die with every repetition. Finally, the die is in particular opened and the fabricated component can be ejected. With internal high-pressure forming, the forming of a metal tube is carried out in the closed forming die by means of an internal pressure of up to 3,000 bar, whereby water or a water-oil emulsion is used as the pressure medium according to the Prior Art. In addition to the heating of the workpiece in particular due to the high pressure of the pressure medium, the temperature for internal high-pressure forming can be specifically adjusted. Internal high-pressure forming can be carried out at room temperature or at a temperature of up to 600° C., for example. The workpiece and/or the die in particular can be pre-heated for this purpose. The highest temperature is applied in particular in the area of the greatest forming of the workpiece.

“Hydraulic back-pressure forming” is in particular a variant of the method of internal high-pressure forming whereby the workpiece is in particular put under internal pressure before the die is closed. With hydraulic back-pressure forming, the hollow part is in particular sealed with the axial cylinders before the die is closed and subjected to a back pressure. Closing the die in particular presses the contour of the component against the hollow part, whereby the back pressure in the hollow part acts as a cushion and prevents the hollow part from collapsing. With hydraulic back-pressure forming, the forming process in particular is largely completed after the die has closed. With hydraulic back-pressure forming, there is in particular no appreciable expansion, so that the process can be carried out with a lower pressure than is required for the internal high-pressure method.

A “fluid” is in particular deemed to be a gas and/or a liquid. A fluid can in particular transfer compressive forces.

“Hardening” is in particular deemed to be a change to the physical properties of the material of the hollow part and/or pipe and/or workpiece. In particular when the workpiece consists of steel or titanium alloys, hardening is in particular deemed to be an increase in the mechanical resistance by specific modification and/or transformation of the micro-structure. Hardening may be carried out in particular by heat treatment followed by fast cooling. The cooling speed in particular is at least 27 kelvin per second and preferably greater than 100 kelvin per second. Hardening is in particular deemed to be a transformation hardening of ferrous metals, whereby a workpiece is heated so that the iron which is present as ferrite at room temperature is transformed into austenite. The austenite accumulates carbon in particular under these conditions and thus can no longer return to the ferrite structure when rapidly cooled. Instead, it transforms into a martensite structure in particular, which is put under strain by the carbon. The higher the speed of cooling in particular and thus the temperature difference, the more martensite forms and the greater the hardness of the material becomes.

“Partial hardening” is in particular a hardening where only sections of a workpiece are hardened, or where a mixed structure of medium hardness is specifically set through only partial austenitisation of the material and subsequent cooling, or where after a partial or complete austenitisation only a partial transformation of the austenite into martensite takes place by specifically slow cooling and thus a mixed structure of medium hardness is produced, or which only occurs for a portion of the material of the workpiece. A “complete hardening” (also called full hardening) is in particular a hardening of steel where the martensite hardening occurs across the whole material cross-section of the workpiece. For a complete hardening, a sufficient speed of cooling must be achieved in particular inside the workpiece as well.

“Hardening temperature” is in particular deemed to be the temperature at which an increase in its mechanical resistance is achieved for a material and/or a workpiece. With steel in particular, the hardening temperature is deemed to be the austenitising temperature at which iron transforms from the austenite into the martensite structure when cooled. With steel, the austenitising temperature in particular is above 723° C. A “first hardening temperature” is in particular the temperature at which a structural modification of a material and/or workpiece starts. The first hardening temperature is in particular above 600° C. For steel, the first hardening temperature corresponds in particular to the Ac1-temperature at which the formation of austenite starts when it is heated. For example, the Ac1 temperature for a 22MnB5 steel in particular is 720° C. (temperature at which the formation of the austenite starts during heating) for partial austenitisation, while the Ac3 temperature for a complete austenitisation is 845° C. (temperature at which the transformation of the ferrite into austenite finishes when heated).

A “melting point of zinc phases” is in particular the temperature at which solid zinc transfers into liquid zinc phases. Above this “melting point”, micro-cracks can form due to liquid metal embrittlement during the forming process in particular. The melting point of pure zinc is in particular at 419° C.

“Essentially without any forming” is deemed to mean that no specifically applied forming is carried out during the hardening and/or cooling, but a slight plastic deformation of the workpiece may occur due to the thermal elongation or contraction or through being pressed into a cold die form.

In a further embodiment of the method, the fluid comprises water, oil, a mixture of water and oil and/or a gas, in particular a shielding gas.

Internal high-pressure forming and/or hydraulic back-pressure forming can thus be carried out by means of water, oil, or a mixture of oil and water and/or a gas.

It is in particular advantageous to use a gas for the internal high-pressure forming and/or hydraulic back-pressure forming, since this does not lead to any problems with warm internal high-pressure forming at a temperature above 100° C. and/or in the interior of the hollow part during the subsequent heating to a temperature above 100° C. for the hardening. When water is used as the pressure medium for internal high-pressure forming and/or hydraulic back-pressure forming, however, it remains in the interior of the pipe and causes disturbances to the hardening process above the first hardening temperature by vaporizing as it is heated.

It is particularly advantageous that the use of a shielding gas for the internal high-pressure forming and/or hydraulic back-pressure forming avoids edge oxidation and/or decarbonisation during the heating phase to above the austenitising temperature of 723° C. during the subsequent hardening.

A substance is in particular a “gas” when its particles move independently of each other with a large mutual separation and uniformly fill the space available.

A “shielding gas” is in particular a gas or gas mixture whose task is to displace the air of the ambient atmosphere and in particular the oxygen in the air. A shielding gas is in particular nitrogen and/or noble gases such as helium, neon, argon and a few more.

To be able to carry out the forming process with little effort and at low pressure, the internal high-pressure forming and/or hydraulic back-pressure forming is carried out above a vaporization temperature, in particular above 100° C.

A temperature above a vaporization temperature makes the workpiece “more pliant” and it can thus be formed at a lower pressure.

A “vaporization temperature” is in particular the temperature at which a fluid, a liquid or a mixture of liquids undergoes a phase transition into the gaseous state. Above the vaporization temperature, a fluid in particular is in the gaseous state.

To achieve a rapid heating of the workpiece, the heating of the workpiece is done by inductive heating by means of an induction coil.

This means the workpiece can be heated directly after the forming while still inside the die, where advantageously an induction coil or several induction coils is or are arranged directly within the die on its inner contour.

It is also possible to arrange an induction coil outside the die inside or outside the press, and to move the workpiece into the heating region of the induction coil for the heating after the forming, the induction coil being wound around the workpiece in the heating region, for example.

A heating to the austenitisation temperature and/or hardening temperature and/or another desired temperature can thus be achieved in a very short time.

In addition, there is no need to transfer the workpiece when an induction coil or several induction coils are arranged inside the die.

An “induction coil” is in particular a coil through which in particular low-frequency and/or medium-frequency alternating current and/or RF alternating current flows and thus generates an alternating magnetic field, which induces eddy currents in the workpiece and/or pipe, thereby heating the pipe in particular. This is particularly advantageous since the heat is generated directly in the workpiece and/or hollow part and/or pipe itself and does not have to be transmitted by thermal conduction from a heating device to the workpiece and/or hollow part and/or pipe. For the inductive heating of the workpiece and/or hollow part and/or pipe, in particular a gap and/or separation between the induction coil and/or the workpiece and/or the hollow part and/or the pipe must be maintained.

In a further embodiment of the method, the cooling of the workpiece is achieved by means of a cooling device inside or outside the press.

This makes it possible to realize very fast cooling with no transfer time or with a very short transfer time after the internal high-pressure forming and/or hydraulic back-pressure forming. The time between the heating and quenching of one part of the workpiece can be kept below 5 s, for example, in particular below 3 s, and is thus half as long as with the transfer. This therefore additionally allows a very high cooling speed and/or large temperature difference to be achieved within a very short time so that the martensite content of the workpiece increases and greater hardness can be achieved. To this end, the cooling device can be arranged above or around the die so that the complete workpiece is hardened. The immediate quenching of the workpiece after the heating means only very little scale and/or burn-off is produced.

Likewise, the formed workpiece can be very rapidly submerged in a cooling bath by means of a gripping device, for example, and thus a complete hardening of the workpiece can be realized.

The “cooling device” is in particular a bath filled with and/or a spray operated with oil, water and/or a mixture of oil and water and/or another liquid.

To produce higher-strength zinc-coated hollow components, the coating of the workpiece contains zinc.

A liquid-metal embrittlement with micro-cracks can thus be avoided by internal high-pressure forming and/or hydraulic back-pressure forming below the temperature of liquid zinc phases and the rapid heating and cooling of the zinc-coated workpiece, since no major forming occurs when liquid zinc phases are present.

Alternatively, the hardening of a zinc-coated workpiece can also be brought about by complete heating in an oven which is arranged inside or outside the press, and/or cooling with or without the presence of gas in the die.

In a further embodiment of the method, the hardening is alternatively or additionally done by completely heating the workpiece in an oven and/or cooling the workpiece in the at least one die so that the component is essentially free of cracks.

The die here serves as a pure cooling tool without significant forming taking place during hardening.

“Essentially free of cracks” means that no or only few micro-cracks occur. In particular, no cracks larger than 40 μm occur.

To realize the advantage that the component is free of burn-off, the hardening is alternatively or additionally undertaken in a sealed space or in an oven in a shielding gas atmosphere and/or the cooling in a cooling device in a shielding gas atmosphere in the case of an uncoated workpiece.

“Burn-off loss” in particular describes the loss of material which results from burning, vaporization, spraying, slagging and/or scaling.

In a further embodiment of the method, the workpiece is bent and/or the workpiece is formed before the internal high-pressure forming and/or hydraulic back-pressure forming.

Complex forms of the workpiece can thus be produced and/or the workpiece can be bent and/or pre-formed before the forming.

The workpiece can also be pre-heated before the internal high-pressure forming and/or hydraulic back-pressure forming to lower the yield point and/or to increase the forming capability. The workpiece can likewise be pre-heated before the bending and/or pre-forming of the workpiece to lower the yield point and/or to increase the forming capability.

In a further aspect of the invention, the objective is solved by a component, where the component is a zinc-coated hollow part, in particular a zinc-coated pipe, or an uncoated hollow part, in particular an uncoated pipe, and the component has been fabricated according to an above-described method so that the component is free of burn-off and/or cracks.

A high-quality, higher-strength component with complex forms can thus be fabricated.

Since the fabrication of the component involves the direct forming of a hollow part and/or pipe and not a flat blank and/or not a metal sheet, fewer joining operations are necessary in the fabrication.

A direct coupling of the process steps internal high-pressure forming and/or hydraulic back-pressure forming and the partial or complete hardening allows a simple interlinked production method and avoids additional effort for stacking, separating and destacking.

In an additional aspect of the invention, the objective is solved by a press to fabricate a component, whereby the press is set up such that the forming and/or hardening of the component can be carried out according to an above-described method, the press having a device for the internal high-pressure forming and/or hydraulic back-pressure forming and/or a device for hardening by heating and cooling, in particular an induction coil and/or a liquid spray and/or a bath of liquid.

A press can thus be provided in which high-quality and higher-strength components can be fabricated with short production times.

It is in particular advantageous to carry out the method combination of internal high-pressure forming and/or hydraulic back-pressure forming and the partial or complete hardening directly within the press so that there is no need to transfer the workpiece and the production times can be shortened.

In the following, the invention is explained in more detail with the aid of embodiments. The following are shown in the diagrams

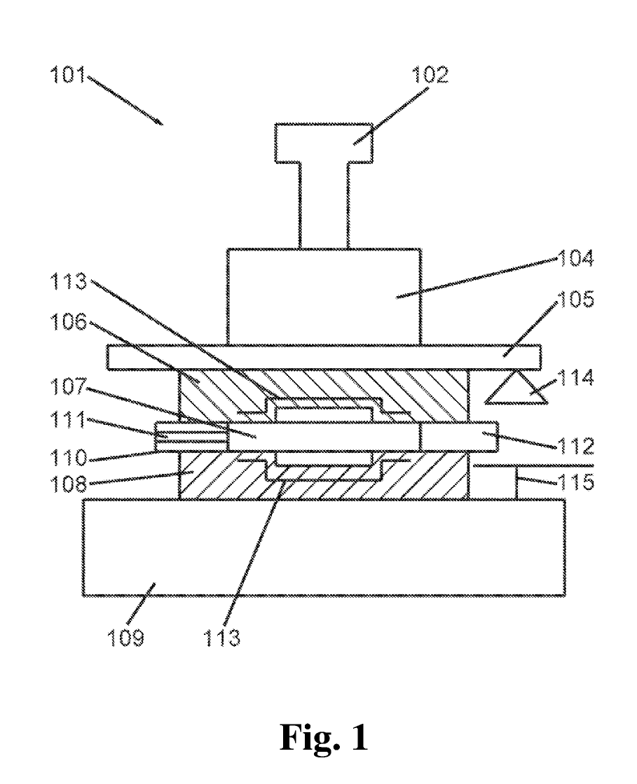

FIG. 1 a schematic cross-sectional view of a press with closed die for the internal high-pressure forming of an uncoated pipe and

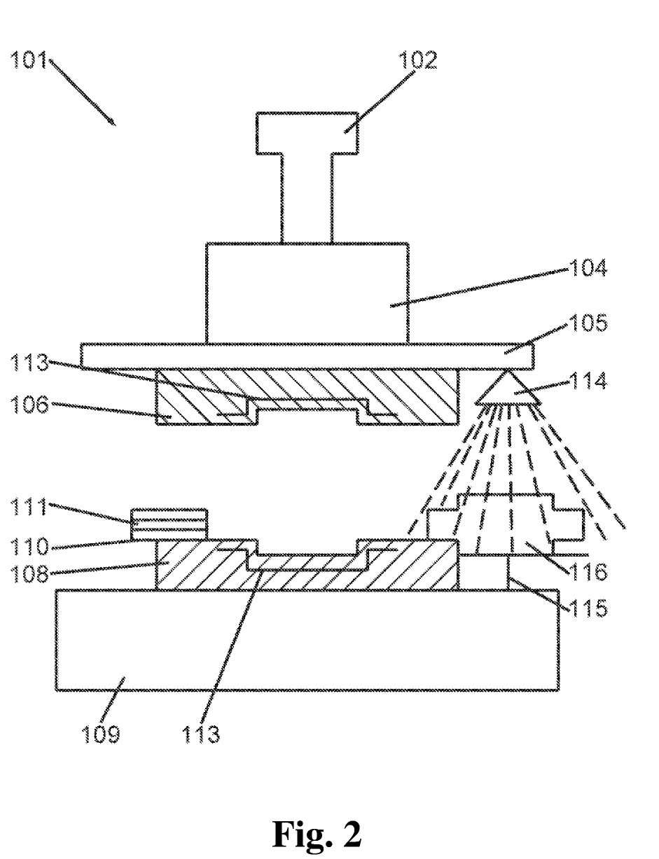

FIG. 2 a schematic cross-sectional view of the press with opened die and cooling of a fabricated catalytic converter housing by means of a water spray.

A press 101 has a drive 102 and a ram 104. A jig 105 which holds the upper half of the die 106 is arranged on the ram 104. The lower half of the die 108 is arranged on a press bed 109. An uncoated pipe 107 made of 22MnB5, whose pipe ends 112 are in contact with a first axial sealing punch 110 and with a second axial sealing punch 112 lies in the lower half of the die 108. The first axial sealing punch 110 has a fluid feed 111. Induction coils 113 follow the inner contour of the upper half of the die 106 and the lower half of the die 108 within both the upper half of the die 106 and the lower half of the die 108.

A water spray 114 is arranged outside on the underside of the jig 105, and a transport rail 115 is arranged on the press bed 109 below the water spray.

The following processing steps are realized with the press 101 by cold internal high-pressure forming at a room temperature of 20° C. and complete hardening:

The upper half of the die 106 and the lower half of the die 108 are opened in the press 101. An uncoated pipe 107 is put into the lower half of die 108 by means of a gripper tool which is not shown. The upper half of the die 106 and the lower half of the die 108 are closed and a pressing force of 35,000 kN is applied.

Parallel to the increase in the pressing force, the first axial sealing punch 110 and the second axial sealing punch 112 are moved towards the ends of the uncoated pipe 107 and seal the pipe 107. Nitrogen as the pressure medium and shielding gas is fed into the inside of the uncoated pipe 107 via the fluid feed 111 of the first axial sealing punch 110. This causes a pressure of 800 bar to build up.

The uncoated pipe 107 is compressed by the first axial sealing punch 110 and the second axial sealing punch 112, while the axial flow of material and the expansion and the close fitting of the uncoated pipe to the inner contour of the upper half of the die 106 and the lower half of the die 108 is carried out by the nitrogen pressure medium.

By setting the calibration pressure of 1,000 bar, the uncoated pipe is formed so as to be a perfect fit so that it assumes the inner contour of the upper half of the die 106 and the lower half of the die 108 as its outer contour. The formed, uncoated pipe 107 is subsequently heated in the closed upper half of the die 106 and lower half of the die 108 by means of the induction coils 113 to a hardening temperature of 900° C. within 3 seconds.

The pressing force is then relieved and the upper half of the die 106 and the lower half of the die 108 are opened. The second axial sealing punch 112 is moved to outside the press and the formed uncoated pipe 107 is brought onto the transport rail 115 by means of a gripping tool which is not shown here. The transfer time here is 3 seconds.

As soon as the formed, uncoated pipe 107 is on the transfer rail 115, the water spray 114 is triggered automatically, the formed, uncoated pipe 107 is completely cooled down and thus hardened.

This produces the catalytic convertor housing 116 fabricated from the uncoated pipe 107 by forming and hardening. The catalytic convertor housing 116 fabricated is a high-strength, high-quality component with a yield point of 750 MPa and with very little scaling and low burn-off so that a further process step of shot peening is not necessary. Neither does the catalytic convertor housing 116 warp with this fabrication method.

In an alternative, the processing steps described are carried out in the press 101 using a zinc-coated pipe 107 in a warm internal high-pressure forming with argon as the pressure medium and shielding gas at a temperature of 500° C., which is above the vaporization point of water and below the melting point of zinc phases. The pipe is thus formed at this temperature. Subsequently, the pipe is heated to 800° C. and quenched so that a hardened and zinc-coated pipe is produced.

### KEY

101 press
102 drive
104 ram
105 jig
106 upper half of die
107 uncoated pipe
108 lower half of die
109 press bed
110 first axial sealing punch
111 fluid feed
112 second axial sealing punch
113 induction coil
114 water spray
115 transport rail
116 fabricated catalytic convertor housing

1-11. (canceled)

12. A method to produce a component from a workpiece via a press which comprises at least one die to form the workpiece, wherein the workpiece comprises at least one of a metal, a metal alloy and a coating and has a form of a hollow part, the method comprising:
internal high-pressure forming and/or hydraulic back-pressure forming the workpiece via a fluid and the at least one die, the internal high-pressure forming and/or the hydraulic back-pressure forming being conducted at a temperature below a first hardening temperature of the workpiece; and
subsequently partially or completely hardening the workpiece by heating the workpiece above the first hardening temperature and then immediately cooling the workpiece, the heating and the cooling each being essentially conducted without a forming so that a fabricated component results.

13. The method as recited in claim 12, wherein,
the first hardening temperature is below a melting point of zinc phases; and
the heating of the workpiece above the first hardening temperature is to a temperature of above 700° C.

14. The method as recited in claim 13, wherein the temperature is above 840° C.

15. The method as recited in claim 12, wherein the fluid comprises at least one of water, an oil, a mixture of water and the oil, and a gas.

16. The method as recited in claim 15, wherein the gas is a shielding gas.

17. The method as recited in claim 12, wherein the internal high-pressure forming and/or hydraulic back-pressure forming is performed above a vaporization point of the fluid.

18. The method as recited in claim 17, wherein the vaporization point is above 100° C.

19. The method as recited in claim 12, wherein the heating of the workpiece is performed via an inductive heating using an induction coil.

20. The method as recited in claim 12, wherein the immediate cooling of the workpiece is performed via a cooling device arranged inside or outside of the press.

21. The method as recited in claim 12, wherein the coating of the workpiece comprises zinc.

22. The method as recited in claim 21, wherein the partial or complete hardening of the workpiece is performed by,
heating the workpiece above the first hardening temperature in an oven, and
cooling the workpiece in the at least one die,
so that the component is essentially free of cracks.

23. The method as recited in claim 12, wherein, when the workpiece is an uncoated workpiece, at least one of,
the partial or complete hardening of the workpiece is performed in a sealed space or in an oven in a shielding gas atmosphere, and
the immediate cooling of the workpiece is performed in a cooling device in the shielding gas atmosphere so that the workpiece is free of burn-off.

24. The method as recited in claim 12, further comprising:
at least one of bending and pre-forming the workpiece prior to the internal high-pressure forming and/or hydraulic back-pressure forming.

25. A component manufactured pursuant claim 12, wherein,
the component is a zinc-coated hollow part or an uncoated hollow part, and
the component is manufactured so as to be free of at least one of a burn-off and cracks.

26. The component as recited in claim 25, wherein
the zinc-coated hollow part is a zinc-coated pipe, and
the uncoated hollow part is an uncoated pipe.

27. A press configured to produce the component pursuant to the method as recited in claim 12, the press comprising:
a first device for the internal high-pressure forming and/or hydraulic back-pressure forming; and
a second device for subsequently partially or completely hardening the workpiece by heating the workpiece above the first hardening temperature and then immediately cooling the workpiece.

28. The press as recited in claim 27, wherein the second device is at least one of an induction coil, a liquid spray, and a bath of a liquid.
